(19) United States
(12) Patent Application Publication
(10) Pub. No.: US 2006/0189357 A1
(43) Pub. Date: Aug. 24, 2006

(54) Mobile communication apparatus and method for altering telephone audio functions

(75) Inventor: Tzu-Che Hsueh, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 10/989,309

(22) Filed: Feb. 22, 2005

(51) Int. Cl. H04B 1/38

(52) U.S. Cl. 455/567

(57) ABSTRACT

A mobile communication apparatus and method aim to alter telephone audio functions. The communication apparatus according to the invention includes a sound generating module, a sound altering module, and a sound broadcasting module. The sound generating module generates telephone audio signals that include a user's speaking voice, a ringtone and a receiving sound. The sound altering module changes the telephone audio signals to a preset altered sound. The sound broadcasting module broadcasts the preset altered sound.

### BACKGROUND OF THE INVENTION

(1) Field of the Invention

The invention relates to a mobile communication apparatus and method capable of altering telephone audio functions.

(2) Description of the Prior Art

In recent years mobile communication devices is very popular. The mobile communication devices such as communication apparatuss have become necessary items in the daily life of many people. To the manufacturers of the mobile communication devices, especially the communication apparatuss, in order to increase sales of the mobile communication devices, they have to continuously enhance the added value of the mobile communication devices. In addition to improving the convenience of button dialing, data processing function and fashionable style, ringtone design also is one of the focuses to increase the added value of the mobile communication devices.

The conventional techniques for ringtone design include ringtone editing, ringtone setting and the like. Aside from the ringtone editing, the mobile communication device that can directly alter the ringtone is an exciting feature to many consumers. R.O.C. patent application No. 90117764 discloses a mobile communication device and method that can identify and transform ringtone. It provides a technique to transform a received ringtone according to a ringtone format and a ringtone conversion rule. It offers substantially added value to the consumers and communication apparatus vendors. However in that technique the ringtone is not effective if it is not preset in advance. It also is limited to alter the ringtone of the mobile communication devices.

The sound generated by communication apparatuss, in addition to the ringtone, also include user's speaking voice and receiving sound. Hence besides changing the ringtone like the conventional techniques do, to further altering user's speaking voice and the receiving sound during communication, and allowing the alteration of sound and the ringtone to be switched alternately as desired could greatly boost the added value of the mobile communication devices and benefit the consumers.

Hence the primary object of the invention is to provide a mobile communication apparatus and method that are capable of altering telephone audio functions to solve the aforesaid problems.

### SUMMARY OF THE INVENTION

Accordingly, it is one object of the present invention to provide a mobile communication apparatus and method that are capable of altering telephone audio functions to change user's speaking voice, ringtone and receiving sound.

In one aspect of the present invention, the communication apparatus includes a sound generating module, a sound altering module and a sound broadcasting module. The sound generating module aims to generate telephone audio signals from a user's speaking voice, a ringtone or a receiving sound. The sound altering module aims to change the telephone audio signals to a preset altered sound. The sound broadcasting module aims to broadcast the preset altered sound.

The sound generating module further includes a microphone, a memory, and a mobile transceiver module. The microphone is to receive the user's speaking voice. The memory is to store the ringtone. The mobile transceiver module is used to receive the receiving sound and the phone number of a calling signal.

In another aspect of the present invention, the communication apparatus further includes a setting module to set the phone number corresponding to the preset altered sound. The sound altering module further includes a comparing module to compare the phone number of the calling signal received by the mobile transceiver module and the phone number corresponding to the preset altered sound to enable the sound broadcasting module to broadcast the preset altered sound later.

In a further aspect of the present invention, the sound altering module can change the telephone audio signals to the preset altered sound by controlling the frequency of the telephone audio signals, or through a clock, a time extension device, and a sound composing device.

The clock divides the telephone audio signals to a plurality of phone audio signals according to a broadcasting time set by a selected time interval so that each phone audio signal corresponds to a broadcasting start time. The time extension device aims to extend the broadcasting time of the phone signal by an extended time period. The broadcasting start time of the phone audio signal in the extended broadcasting time period is the broadcasting start time before the time extension. The sound composing device aims to compose the phone audio signal to become the preset altered sound in the extension time period caused by the time extension device according to the broadcasting start time of each phone audio signal.

Thus through the mobile communication apparatus and method of the present invention the telephone audio signals such as user's speaking voice, ringtone and receiving sound may be changed. The ringtone may also be replaced by user's speaking voice and receiving sound to greatly increase the added value of the mobile communication device.

### BRIEF DESCRIPTION OF THE DRAWINGS

The present invention will now be specified with reference to its preferred embodiments illustrated in the drawings, in which

FIG. 1 is a schematic view of a communication apparatus of the present invention;

FIG. 2 is a process flow chart of a first embodiment of the invention;

FIG. 3 is a process flow chart of a second embodiment of the invention;

FIG. 4 is a process flow chart of a third embodiment of the invention;

FIG. 5 is a process flow chart of a fourth embodiment of the invention;

FIG. 6 is a process flow chart of a fifth embodiment of the invention;

FIG. 7 is a process flow chart of a sixth embodiment of the invention;

FIG. 8 is a process flow chart of a seventh embodiment of the invention;

FIG. 9 is a schematic view of a mobile communication apparatus of the invention; and

FIG. 10 is a schematic view of the present invention to alter sound by changing time through a sound altering module.

### DESCRIPTION OF THE PREFERRED EMBODIMENTS

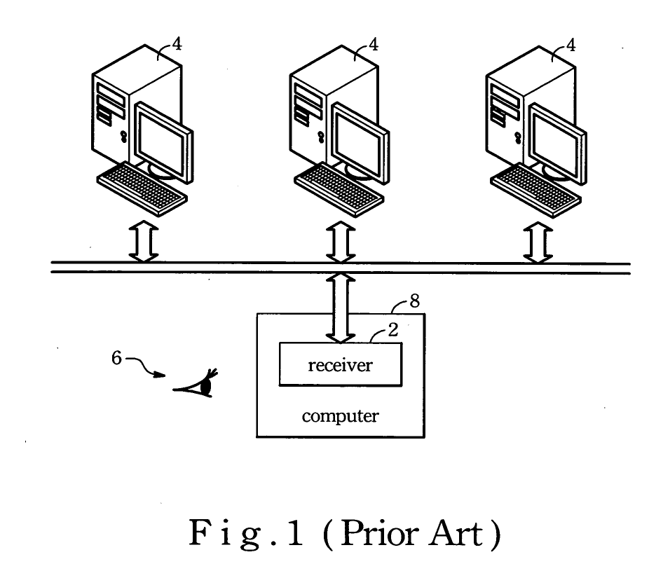

The invention discloses a mobile communication apparatus and method capable of altering telephone audio functions of telephone audio signals that include a user's speaking voice, a ringtone and a receiving sound. Referring to FIG. 1, a communication apparatus 10 according to the present invention includes a sound generating module 12, a setting module 14, a comparing module 15, a sound altering module 16 and a sound broadcasting module 18.

The sound altering module 16 aims to change the telephone audio signals to a preset altered sound. The sound generating module 12 generates the telephone audio signals. It includes a microphone 20, a memory 22 and a mobile transceiver module 24.

The microphone 20 receives the user's speaking voice and changes the speaking voice to the preset altered sound through the sound altering module 16. The sound broadcasting module 18 generates the preset altered sound through the mobile communication device. The preset altered sound may also be transmitted to other communication devices through the mobile transceiver module 24. The preset altered sound corresponding to a selected phone number stored in the memory 22 may also be retrieved and changed through the sound altering module 16 to replace user's speaking voice after comparison and transmitted through the mobile transceiver module 24 to a receiving device corresponding to the phone number away from the mobile communication device and broadcast through a sound broadcasting device of the receiving device.

The mobile transceiver module 24 is to receive the receiving sound and the phone number of a calling signal. The setting module 14 aims to preset the phone number received by the mobile transceiver module 24 or a preset phone number to a corresponding preset altered sound and store in the memory 22. The memory 22 stores the ringtone, phone number and the type of the preset altered sound corresponding to the phone number. The comparing module 15 compares the phone number of the calling signal received by the mobile transceiver module 24 with the phone number corresponding to the preset altered sound set by the setting module 14.

After the mobile transceiver module 24 has received the phone number of the calling signal, and the comparing module 15 has compared the phone number of the calling signal with the corresponding phone number of the preset altered sound set by the setting module 14 that is stored in the memory 22, if they match, the sound altering module 16 changes the telephone audio signals to the preset altered sound corresponding to the phone number, and the preset altered sound is broadcast through the sound broadcasting module 18, such as the ringtone is changed to the corresponding preset altered sound and broadcast through the sound broadcasting module 18. And the receiving sound of the received calling signal is changed to the preset altered sound through the sound altering module 16 and broadcast through the sound broadcasting module 18.

The present invention also provides a method for altering the telephone audio signals of the communication apparatus 10. The telephone audio signals include user's speaking voice, ringtone and receiving sound. The method includes the following steps: first, generate the telephone audio signals; next, change the telephone audio signals to a preset altered sound; finally, broadcast the preset altered sound.

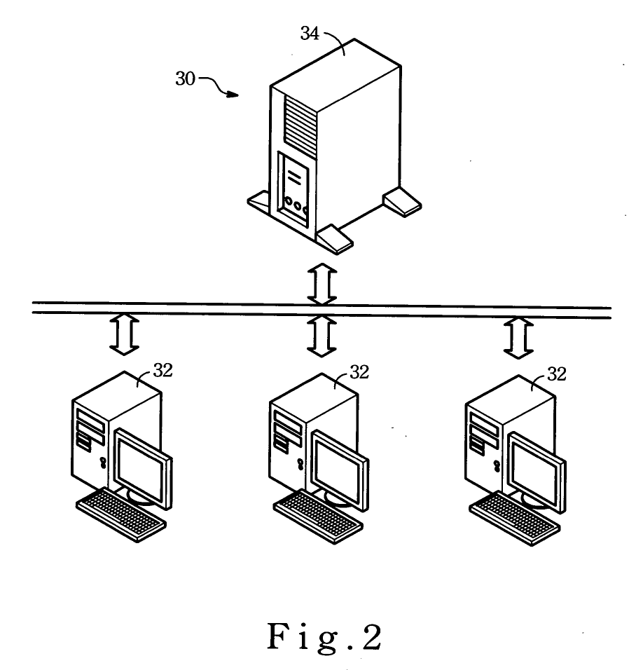

A number of embodiments are discussed as follow accompanying the flow charts to further elaborate the applications adopted on the communication apparatus 10. Refer to FIG. 2 for a first embodiment of the invention. It includes the following steps:

First, step S11, the communication apparatus 10 receives a receiving sound and the phone number of a calling signal, for example, the sound of Mr. A, and the phone number is 1234567;

next, step S12, change and set the receiving sound to the preset altered sound, such as alter the sound of Mr. A to the preset altered sound of Donald Duck;

step S14, set the preset altered sound corresponding to the phone number of the calling signal, such as set the phone number 1234567 corresponding to the preset altered sound of Donald Duck;

step S15, finish the calling signal of the phone number 1234567;

step S16, receive a receiving sound and a phone number of another calling signal;

step S17, compare the phone number of another calling signal with the set phone number corresponding to the preset altered sound; if the two phone numbers are different, go to Step S18 to directly broadcast the receiving sound through the communication apparatus 10; and

step S19, if the two phone numbers match, such as the phone number of another calling signal also is 1234567, the communication apparatus 10 broadcasts the preset altered sound rather than the receiving sound, namely change the receiving sound to the preset altered sound of Donald Duck, thus communication and conversation will become more amusing and intimate. Of course, the caller could be Mr. A. In the event that the caller is Mr. B, his receiving sound will still be changed to the preset altered sound of Donald Dick, as the communication apparatus 10 recognizes only the received phone number.

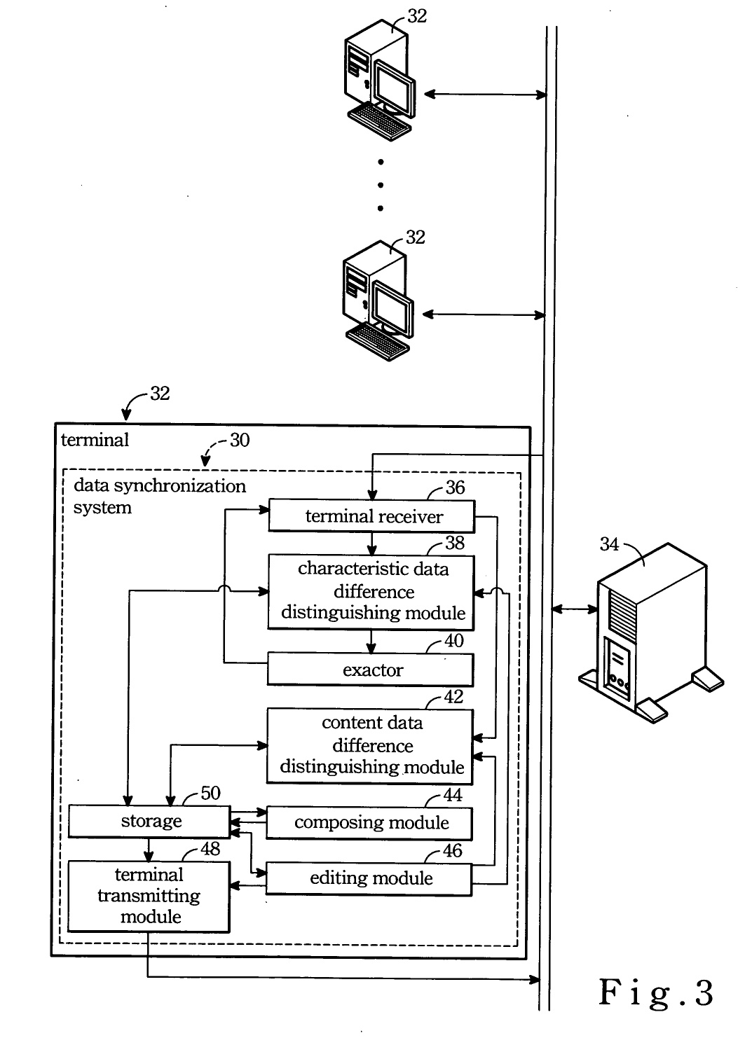

Refer to FIG. 3 for a second embodiment of the invention adopted on the communication apparatus 10. It includes the following steps:

First, step S22, enter a phone number to set a preset altered sound corresponding to the phone number, such as enter phone number 1234567, and set the preset altered sound of Donald Duck corresponding to the phone number 1234567;

step S24, the communication apparatus 10 receives a receiving sound and a phone number of a calling signal;

step S26, compare the phone number of the calling signal with the set phone number corresponding to the preset altered sound; if the two phone numbers are different, go to Step S27 to directly broadcast the receiving sound through the communication apparatus 10; and

step S28, if the two phone numbers match, such as the phone number of the calling signal also is 1234567, broadcast the preset altered sound instead of the receiving sound, namely change the receiving sound to the preset altered sound of Donald Duck, therefore communication and conversation will become more amusing and intimate.

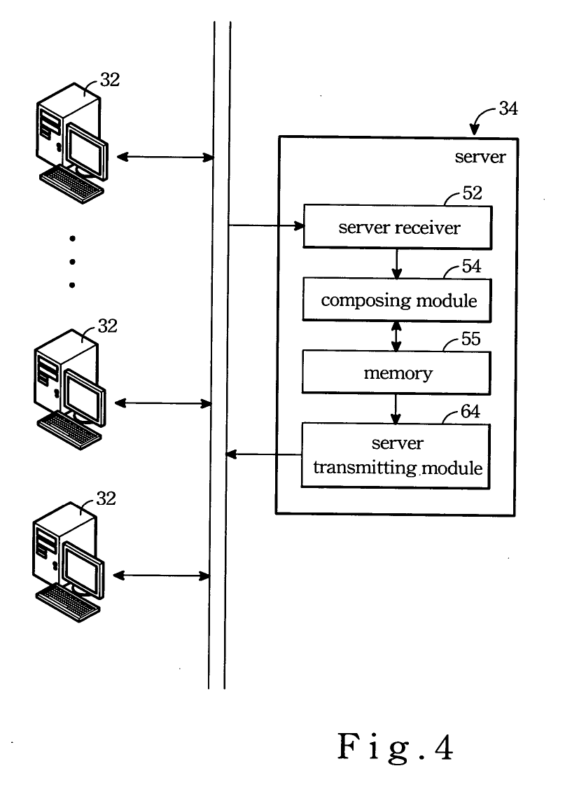

Refer to FIG. 4 for a third embodiment of the invention adopted on the communication apparatus 10. It includes the following steps:

First, step S32, the communication apparatus 10 receives a receiving sound of a calling signal, such as the sound of Mr. A;

next, step S34, set the receiving sound to the preset altered sound, such as set the sound of Mr. A to the preset altered sound of Donald Duck; and

finally, Step 36, the communication apparatus 10 broadcasts the preset altered sound rather than the receiving sound, namely change the receiving sound of Mr. A to the preset altered sound of Donald Duck for broadcasting, therefore communication and conversation will become more amusing and intimate.

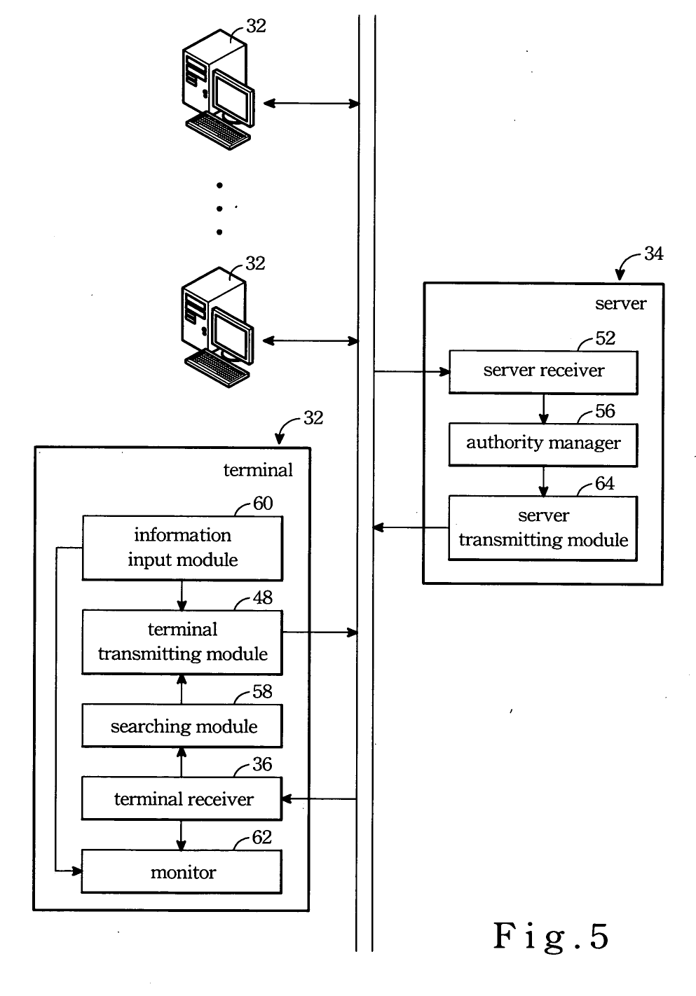

Refer to FIG. 5 for a fourth embodiment of the invention adopted on the communication apparatus 10. It includes the following steps:

First, step S42, the communication apparatus 10 receives a phone number of a calling signal, for example, the phone number is 1234567, and the user is Mr. A;

next, step S43, change and set the ringtone to the preset altered sound, such as alter the ringtone to the piano melody of “It's a wonderful world”, therefore change of the sound of Mr. A to the melody of “It's a wonderful world”;

step S44, set the preset altered sound corresponding to the phone number of the calling signal, such as set the ringtone of phone number 1234567 to the preset altered sound of Mr. A;

step S45, finish the calling signal of the phone number 1234567;

step S46, the communication apparatus 10 receives a phone number of another calling signal;

step S47, compare the phone number of another calling signal with the set phone number corresponding to the preset altered sound; if the two phone numbers are different, go to Step S48 to directly broadcast the ringtone through the communication apparatus 10; and

step S49, if the two phone numbers match, such as the phone number of another calling signal also is 1234567, the communication apparatus broadcasts the preset altered sound rather than the receiving sound, namely change the receiving sound of Mr. A to the preset altered sound of the melody “It's a wonderful world”, therefore communication and conversation will become more amusing and intimate.

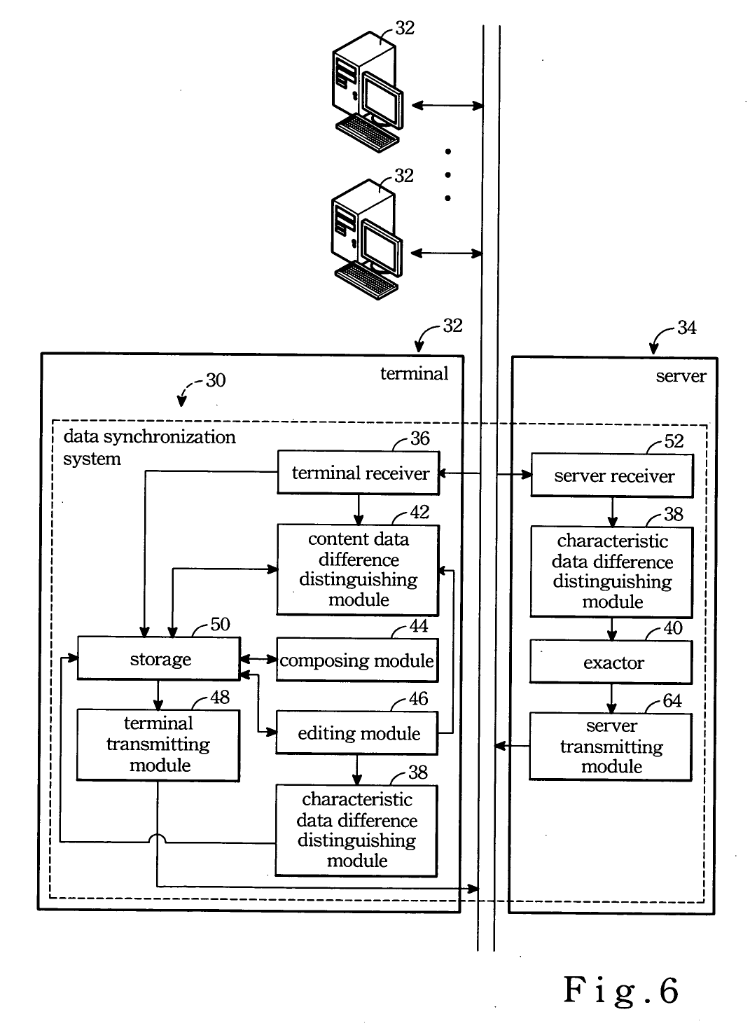

Refer to FIG. 6 for a fifth embodiment of the invention adopted on the communication apparatus 10. It includes the following steps:

First, step S52, enter a phone number to set a ringtone for the phone number to become the preset altered sound corresponding to the phone number, such as enter phone number 1234567, and set the ringtone corresponding to the phone number 1234567 to become the preset altered sound of Mr. A;

step S54, the communication apparatus 10 receives a phone number of a calling signal;

step S56, compare the phone number of the calling signal with the set phone number corresponding to the preset altered sound; if the two phone numbers are different, go to Step 57 to directly broadcast the ringtone through the communication apparatus 10; and

step S58, if the two phone numbers match, such as the phone number of the calling signal also is 1234567, the communication apparatus 10 broadcasts the preset altered sound instead of the ringtone, namely broadcast the preset altered sound of Mr. A rather than the ringtone to make communication and conversation more amusing and intimate.

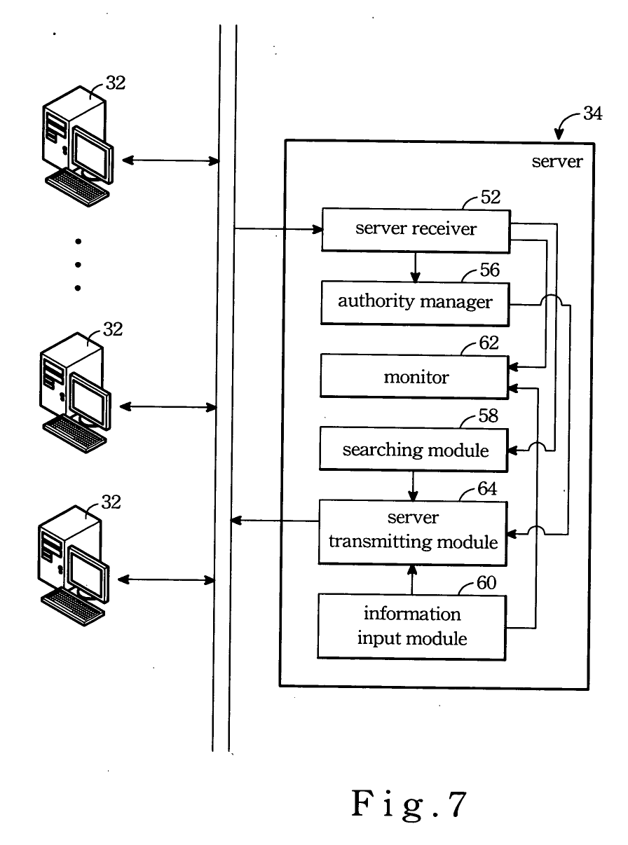

Refer to FIG. 7 for a sixth embodiment of the invention adopted on the communication apparatus 10. It includes the following steps:

First, step S62, enter a phone number to set a preset altered sound corresponding to the phone number, such set a preset altered sound of Donald Duck corresponding to phone number 1234567;

step S63, the communication apparatus 10 establishes a communication link with the phone number, namely the communication apparatus 10 establishes a communication link with the phone number 1234567;

step S64, user Mr. C of the communication apparatus 10 generates a user receiving sound, namely the user Mr. C makes a phone call by speaking;

step S65, the corresponding phone number automatically changes the receiving sound to the preset altered sound, namely the receiving sound of Mr. C is changed to the preset altered sound of Donald Duck corresponding to phone number 1234567; and

finally, step 66, transmit the preset altered sound caused by the user speaking to the communication device of the phone number, namely the receiving sound of Mr. C is changed to the preset altered sound of Donald Duck and is sent to the communication device of the phone number 1234567 to make communication and conversation more amusing and mysterious.

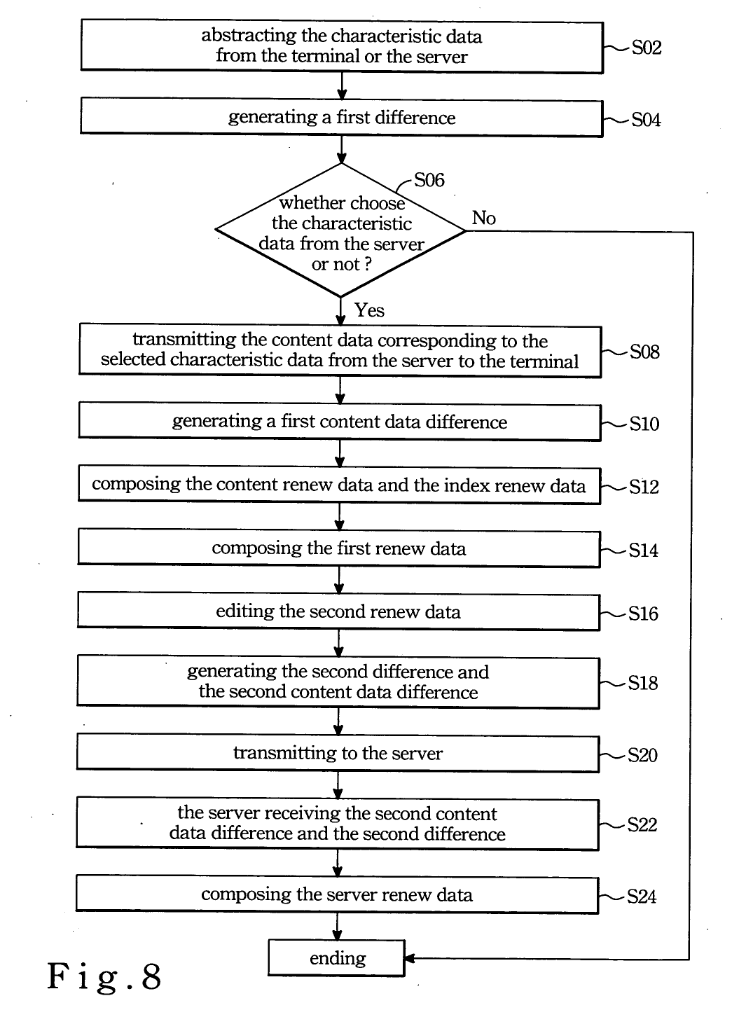

Refer to FIG. 8 for a seventh embodiment of the invention adopted on the communication apparatus 10. It includes the following steps:

First, step S72, establish a communication link between the communication apparatus 10 and a communication device of the phone number 1234567;

step S74, user Mr. C of the communication apparatus 10 generates a user receiving sound;

step S76, change the user receiving sound of Mr. C to a preset altered sound of Donald Duck; and

finally, step S78, transmit the preset altered sound caused by user's speaking to the communication device of the phone number, namely the communication apparatus 10 transmits the preset altered sound of Donald Duck changed by Mr. C's speaking to the communication device of the phone number 1234567 to make communication and conversation more amusing and mysterious.

The communication apparatus 10 according to the invention, in addition to the applications set forth above, also can download audio file data from wireless communication devices and change and broadcast the sound. For instance, if the audio file data are MP3 audio files or the like, they also can be treated as the telephone audio signals and be altered through the communication apparatus 10 of the invention to increase amusement. The embodiments previously discussed serve only illustrative purpose, and are not the limitation of the invention.

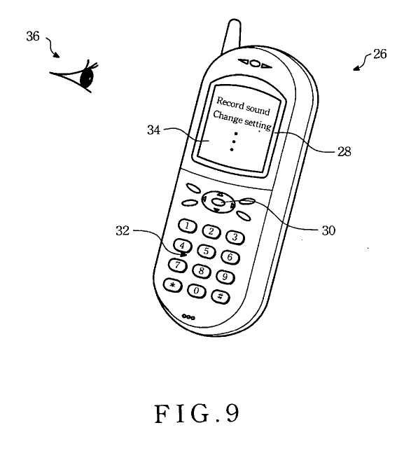

Referring to FIG. 9, the communication apparatus 10 according to the invention includes a display 28, a function key 30 and numeral keys 32. The display 28 aims to display a menu picture 34 to enable a user 36 to see. The user 36 observes a plurality of preset altered sound selections in the menu picture 34 displayed on the display 28, and selects the desired preset altered sound to be set through the function key 30. The numeral keys 32 aims to enter the phone number corresponding to the preset altered sound set by the setting module 14 in the follow on process.

Further more, in the communication apparatus 10, the sound altering module 16 can change the telephone audio signals to the preset altered sound by controlling the frequency of the telephone audio signals, or through a clock 38, a time extension device 40 and a sound composing device 42. More details are elaborated as follow:

The sound altering module 16 can change the telephone audio signals to the preset altered sound by controlling the frequency of the telephone audio signals. Controlling the frequency of the telephone audio signals can be accomplished through a filter (not shown in the drawings) by selecting the telephone audio signals of frequencies within a selected range; or through a frequency amplifier (not shown in the drawings) to amplify the frequency of the telephone audio signals to change the original telephone audio signals to the preset altered sound.

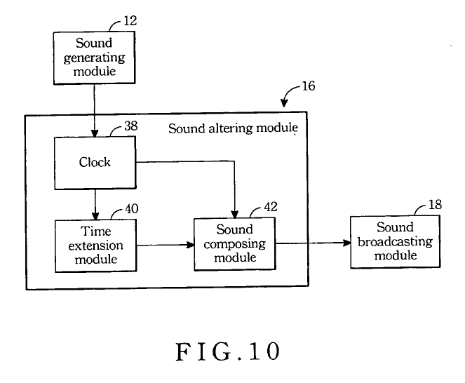

Refer to FIG. 10 for changing the sound by altering time through the sound altering module 16. The sound altering module 16 further includes a clock 38, a time extension device 40 and a sound composing device 42.

The clock 38 divides the telephone audio signals generated by the sound generating module 12 to a plurality of phone audio signals according to a broadcasting time of a selected time interval. Each phone audio signal corresponds to a broadcasting start time. The time extension device 40 extends the broadcasting time of the phone audio signal corresponding to the selected time interval. The broadcasting start time of the phone audio signal in the extended time period is the broadcasting start time before the time extension. The sound composing device 42 aims to compose the phone audio signals in the extend time extended for a selected time period by the time extension device 40 to become the preset altered sound according to the broadcasting start time corresponding to each phone audio signal to allow the sound broadcasting module 18 to broadcast the preset altered sound later.

The procedure of the sound altering module 16 to change the sound by altering the time includes the following steps: first, set a preset time interval as the broadcasting time, and divide the telephone audio signals into a plurality of phone audio signals, each phone audio signal corresponds to a broadcasting start time; next, the broadcasting time corresponding to the phone audio signal is extended for a selected time period, the broadcasting start time in the extended time period is same as the broadcasting start time before the time extension; finally, based on the broadcasting start time corresponding to each phone audio signal, the phone audio signals in the extended broadcasting time period extended by the time extension device 40 are composed to become the preset altered sound and be broadcast later.

Thus through the communication apparatus 10 and the method of the invention, the telephone audio signals of the communication apparatus 10 may be changed, including user's speaking voice, ringtone and receiving sound. Furthermore, user's speaking voice and the receiving sound may replace the ringtone. Therefore the added value of the communication apparatus 10 increases.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A mobile communication apparatus for altering telephone audio signals that include a receiving sound, comprising:
a mobile transceiver module for receiving the receiving sound of a calling signal and a phone number of the calling signal;
a sound altering module for changing the receiving sound to a preset altered sound;
a setting module for setting a preset phone number and the preset altered sound corresponding to the preset phone number;
a comparing module for comparing the phone number of the calling signal received by the mobile transceiver module with the preset phone number set by the setting module; and
a sound broadcasting module for broadcasting the preset altered sound;
wherein the sound altering module changes the receiving sound to the preset altered sound when the phone number of the calling signal matches the preset phone number and the sound broadcasting module broadcasts the preset altered sound.

2. The mobile communication apparatus of claim 1, wherein the telephone audio signals further include a user's speaking voice and a ringtone, the sound altering module changing the receiving sound, the user's speaking voice and the ringtone to the preset altered sound according to a preset sound altering model.

3. The mobile communication apparatus of claim 2 further including a microphone to receive the user's speaking voice.

4. The mobile communication apparatus of claim 2, wherein the sound altering module changes the ringtone to the preset altered sound according to the preset sounding altering model to allow the sound broadcasting module to broadcast the preset altered sound later.

5. The mobile communication apparatus of claim 2, wherein the sound generating module further includes a memory to store the ringtone, the preset phone number and the preset altered sound corresponding to the preset phone number.

6. The mobile communication apparatus of claim 2, wherein the preset sound altering model changes the telephone audio signals to the preset altered sound by controlling the frequency of the telephone audio signals.

7. The mobile communication apparatus of claim 2, wherein the sound altering module further includes:
a clock to divide the telephone audio signals into a plurality of phone audio signals according to a broadcasting time defined by a preset time interval, each phone audio signal corresponding to a broadcasting start time;
a time extension device to extend the broadcasting time for a selected time period, the start time of the phone audio signal in the extended broadcasting time being the broadcasting start time before the extension; and
a sound composing device to compose the phone audio signal in the extended broadcasting time according to the broadcasting start time of each phone audio signal to allow the preset altered sound module to change the telephone audio signals to the preset altered sound.

8. A mobile communication apparatus for altering telephone audio signals that include a receiving sound, comprising:
a mobile transceiver module for receiving the receiving sound of a calling signal and a phone number of the calling signal;
a sound generating module for generating the telephone audio signals;
a sound altering module for changing the telephone audio signals to a preset altered sound; and
a sound broadcasting module for broadcasting the preset altered sound;

9. The mobile communication apparatus of claim 8, wherein the telephone audio signals include a user's speaking voice, a ringtone and the receiving sound.

10. The mobile communication apparatus of claim 9, wherein the sound generating module further includes:
a microphone for receiving the user's speaking voice;
a memory for storing the ringtone; and
a mobile transceiver module for receiving the receiving sound of a calling signal and the phone number of the calling signal.

11. The mobile communication apparatus of claim 10 further including a setting module for setting the phone number to a corresponding preset altered sound.

12. The mobile communication apparatus of claim 11 further including a comparing module for comparing the phone number of the calling signal received by the mobile transceiver module with the phone number corresponding to the preset altered sound set by the setting module to allow the sound altering module to change the telephone audio signals to the preset altered sound corresponding to the phone number.

13. The mobile communication apparatus of claim 11 further including:
a display for displaying a menu picture for a user viewing;
a function key to allow the user to select and confirm a required preset altered sound from a plurality of the preset altered sounds displayed on the menu picture; and
numeral keys for entering the phone number to allow the setting module to set the phone number corresponding to the preset altered sound later.

14. The mobile communication apparatus of claim 8, wherein the preset sound altering model changes the telephone audio signals to the preset altered sound by controlling the frequency of the telephone audio signals.

15. The mobile communication apparatus of claim 8, wherein the sound altering module further includes:
a clock to divide the telephone audio signals into a plurality of phone audio signals according to a broadcasting time defined by a preset time interval, each phone audio signal corresponding to a broadcasting start time;
a time extension device to extend the broadcasting time for a selected time period, the start time of the phone audio signal in the extended broadcasting time being the broadcasting start time before the extension; and
a sound composing device to compose the phone audio signal in the extended broadcasting time according to the broadcasting start time of each phone audio signal to allow the preset altered sound module to change the telephone audio signals to the preset altered sound.

16. A method for altering telephone audio signals of a mobile communication device, comprising the steps of:
generating a telephone audio signal;
altering the telephone audio signal to a preset altered sound; and
broadcasting the preset altered sound.

17. The method of claim 16, wherein the altering the telephone audio signal to a preset altered sound is accomplished by controlling the frequency of the telephone audio signal.

18. The method of claim 16 further including the steps of:
dividing the telephone audio signal into a plurality of phone audio signals according to a broadcasting time period defined by a preset time interval, each of the phone signals corresponding to a broadcasting start time;
extending the broadcasting time for a selected time period, the start time of the phone audio signal in the extended time being the broadcasting start time before extension; and
composing the phone audio signal in the extended broadcasting time according to the broadcasting start time corresponding to each phone audio signal to become the preset altered sound.

19. The method of claim 16, wherein the telephone audio signals includes a user's speaking voice, a ringtone and a receiving sound.

20. The method of claim 19 further including the steps of:
receiving a receiving sound and a phone number of a calling signal;
setting and changing the receiving sound to the preset altered sound;
setting the preset altered sound corresponding to the phone number of the calling signal;
finishing the calling signal;
receiving a receiving sound and another phone number of another calling signal;
comparing the another phone number with the set phone number corresponding to the preset altered sound; and
broadcasting the preset altered sound instead of the receiving sound when the phone numbers match.

21. The method of 19 further including the steps of:
entering a phone number corresponding to the preset altered sound;
receiving another receiving sound and another phone number of a calling signal;
comparing the another phone number with the set phone number corresponding to the preset altered sound; and
broadcasting the preset altered sound instead of the receiving sound when the phone numbers match.

22. The method of 19 further including the steps of:
receiving another receiving sound of a calling signal;
setting and changing the another receiving sound to the preset altered sound; and
broadcasting the preset altered sound changed from the another receiving sound.

23. The method of 19 further including the steps of:
receiving a phone number of a calling signal;
setting and changing the ringtone to the preset altered sound;
setting the preset altered sound corresponding to the phone number of the calling signal;
finishing the calling signal;
receiving another phone number of another calling signal;
comparing the another phone number with the set phone number corresponding to the preset altered sound; and
broadcasting the preset altered sound when the phone numbers match.

24. The method of 19 further including the steps of:
entering a phone number to set the ringtone of the phone number corresponding to the preset altered sound;
receiving another phone number of a calling signal;
comparing the another phone number with the set phone number corresponding to the preset altered sound; and
broadcasting the preset altered sound when the phone numbers match.

25. The method of 19 further including the steps of:
entering a phone number to set the preset altered sound corresponding to the phone number;
establishing a communication link with the phone number;
generating a user's speaking voice;
changing automatically the user's speaking voice according to the phone number to the preset altered sound corresponding to the phone number; and
transmitting the preset altered sound to a communication device of the phone number.

26. The method of 19 further including the steps of:
establishing a communication link with a phone number;
generating a user's speaking voice;
changing the user's speaking voice to the preset altered sound; and
transmitting the preset altered sound to a communication device of the phone number.
